(19) United States
(12) Patent Application Publication
(10) Pub. No.: US 2017/0262183 A1
(43) Pub. Date: Sep. 14, 2017

(54) NON-TRANSITORY COMPUTER-READABLE STORAGE MEDIUM, REDUNDANT SYSTEM, AND REPLICATION METHOD

(71) Applicant: FUJITSU LIMITED, Kawasaki-shi (JP)

(72) Inventor: KAZUHIRO SUZUKI, Kawasaki (JP)

(73) Assignee: FUJITSU LIMITED, Kawasaki-shi (JP)

(21) Appl. No.: 15/444,967

(22) Filed: Feb. 28, 2017

(30) Foreign Application Priority Data
Mar. 11, 2016 (JP) 2016-049018

(51) Int. Cl. G06F 3/06

(52) U.S. Cl. CPC G06F 3/065; G06F 3/0604; G06F 3/0664; G06F 3/067

(57) ABSTRACT

A non-transitory computer-readable storage medium storing a replication program that causes a first information processing apparatus to execute a process, the process including storing update information to a first shared storage area of a first virtual machine, the update information indicating update of data stored in a storage area of a second virtual machine, when an additional update information is stored in the first shared storage area, transmitting the additional update information to a third virtual machine, and causing the third virtual machine to store the additional update information in a second shared storage area of the third virtual machine, the additional update information stored in the second shared storage area being used to update data stored in a storage area of the fourth virtual machine.

### CROSS-REFERENCE TO RELATED APPLICATION

This application is based upon and claims the benefit of priority of the prior Japanese Patent Application No. 2016-049018, filed on Mar. 11, 2016, the entire contents of which are incorporated herein by reference.

### FIELD

The embodiments discussed herein are related to a non-transitory computer-readable storage medium, a redundant system, and a replication method.

### BACKGROUND

In the past, there has been a technology for establishing a virtual system by applying, to physical machines, a virtual system template in which a resource configuration including pieces of information such as the number of virtual machines and Internet Protocol (IP) addresses of the virtual machines and a configuration of application software to operate on the virtual machines are brought together. By applying, for example, the same virtual system template to each of two physical machines connected to each other via a public network, it is possible to cause one of the two physical machines to operate a virtual system of a production system while causing the other physical machine to operate a virtual system of a standby system. In addition, there is a technology called replication, which is used for copying data in real time.

As a related conventional technology, there is a technology in which an operational server device updates its own database and writes changed data into a shared memory and a standby server device reflects, in its own database, the data written into the shared memory, for example. In addition, there is a technology in which updated data on a memory in a currently-used system and update histories of files of an external storage device are acquired and the data and the update histories are transferred to a standby system by the currently-used system via a communication medium, thereby reflecting the data and the update histories in a memory of a standby system and files of an external storage device.

Related technologies are disclosed in Japanese Laid-open Patent Publication No. 2005-293315 and Japanese Laid-open Patent Publication No. 10-049418.

### SUMMARY

According to an aspect of the invention, a non-transitory computer-readable storage medium storing a replication program that causes a first information processing apparatus to execute a process, the process including storing update information to a first shared storage area of a first virtual machine, the update information indicating update of data stored in a storage area of a second virtual machine, both the first virtual machine and the second virtual machine running on the first information processing apparatus, the first shared storage area being accessible from both the first virtual machine and the second virtual machine, the second virtual machine being a virtual machine of active system of data replication, when an additional update information is stored in the first shared storage area, transmitting the additional update information to a third virtual machine, the third virtual machine running on a second information processing apparatus, and causing the third virtual machine to store the additional update information in a second shared storage area of the third virtual machine, the second shared storage area being accessible from both the third virtual machine and a fourth virtual machine running on the information processing apparatus, the fourth virtual machine being a virtual machine of standby system of the data replication, the additional update information stored in the second shared storage area being used to update data stored in a storage area of the fourth virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an operation of a redundant system according to a first embodiment;

FIG. 2 is an explanatory diagram illustrating an example of a hardware configuration of a physical machine;

FIG. 3 is an explanatory diagram illustrating an example of a functional configuration of the redundant system;

FIG. 4 is an explanatory diagram illustrating an example of a storage content of a replication management table;

FIG. 5 is an explanatory diagram illustrating an example of a storage content of a DB management table;

FIG. 6 is an explanatory diagram illustrating an example of a storage content of an extended bin log;

FIG. 7 is an explanatory diagram illustrating examples of storage contents of shared memory management tables;

FIG. 8 is a flowchart illustrating an example of a replication setting processing procedure;

FIG. 9 is a flowchart illustrating an example of a shared memory setting processing procedure;

FIG. 10 is a flowchart illustrating an example of a flag writing processing procedure;

FIG. 11 is a flowchart illustrating an example of a log transmission processing procedure;

FIG. 12 is a flowchart illustrating an example of a log writing processing procedure;

FIG. 13 is an explanatory diagram illustrating an example of an operation of a redundant system according to a second embodiment;

FIG. 14 is an explanatory diagram illustrating an example of a functional configuration of the redundant system;

FIG. 15 is a flowchart illustrating an example of a determination processing procedure;

FIG. 16 is a flowchart illustrating an example of a log copy processing procedure;

FIG. 17 is an explanatory diagram illustrating an example of an operation of a redundant system according to a third embodiment;

FIG. 18 is an explanatory diagram illustrating an example of a functional configuration of the redundant system; and

FIG. 19 is an explanatory diagram illustrating an example of a storage content of a shared memory management table.

### DESCRIPTION OF EMBODIMENTS

However, according to technologies of the related art, it is difficult to perform replication between virtual machines that belong to respective different virtual systems and that each have the same IP address. Specifically, while, in order to perform replication, the two virtual machines are connected to each other, the virtual machines set based on the same virtual system template each have the same local IP address, and accordingly, it is difficult to directly connect the two virtual machines to each other. Therefore, it is conceivable that, within, for example, one virtual system of the two virtual systems, the other virtual system is established. However, this case is accompanied by a change in the virtual system template. In addition, it is difficult for a person who does not understand a content of the virtual system template to change the virtual system template. In addition, while it is conceivable that the two virtual machines are connected via, for example, a public network, it is undesirable from a security point of view. In addition, it is conceivable that Twice network address translation (NAT) is set, for example, thereby avoiding a collision of local IP addresses. However, since packets are copied at a time of rewriting an IP address, a load caused by replication increases.

In one aspect, an object is to provide a replication program, a redundant system, and a replication method, which are each able to efficiently perform replication between virtual machines that belong to respective different virtual systems and that each have the same IP address.

Hereinafter, embodiments of a replication program, a redundant system, and a replication method that are disclosed will be described in detail with reference to drawings.

### Description of First Embodiment

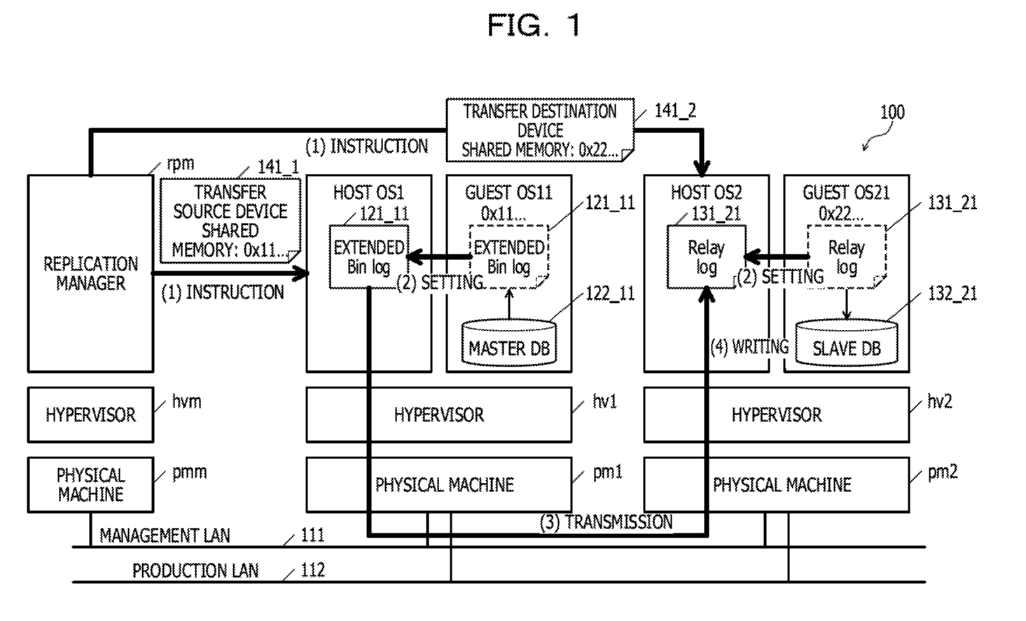

FIG. 1 is an explanatory diagram illustrating an example of an operation of a redundant system 100 according to a first embodiment. The redundant system 100 illustrated in FIG. 1 includes a physical machine pmm, which serves as an instruction device to instruct to perform replication, and physical machines pm1 and pm2. Here, the term “replication” means a technology for copying data in real time. Data to serve as a target may be any type of data and may be, for example, a content of a database (DB), or a file.

In addition, the physical machines pmm, pm1, and pm2 are connected to one another by a management local area network (LAN) 111 as a network. In addition, the physical machines pm1 and pm2 are further connected to each other by a production LAN 112. Here, the production LAN 112 is a network for connecting guest OSs to each other and for transferring production traffic and is connected, via a router or a gateway, to client terminals connected to a public network. On the other hand, the management LAN 111 is a network different from the production LAN 112.

Each of the physical machines pm1 and pm2 is a computer to provide a virtual machine (VM) to a user. Each of the physical machines pm1 and pm2 is, for example, a server. In addition, the physical machines pm1 and pm2 are located within, for example, a data center (DC). Each of the VMs is a computer virtually created by using hardware resources. Each of the VMs may be any type of VM as long as the relevant VM is a virtually created computer. As a program to control VMs, there is a hypervisor. The hypervisor is a program that has a function of directly controlling hardware and that provides a virtual machine architecture in a firmware layer.

The hypervisor is able to cause an operating system (OS) to operate on each of VMs serving as created VMs. On each of the VMs, a guest OS operates. In addition, on one of the VMs, a host OS operates. The host OS is an OS to manage the hypervisor.

In addition, there is a virtual system template in which a resource configuration, which includes, for example, pieces of information related to VMs, such as the number of the VMs and the amounts of memory used by the respective VMs, and information of network IP addresses of the respective VMs, and a configuration of application software to operate on the VMs are brought together. A developer of the virtual system template is different from a provider who deploys, based on the virtual system template, and operates a virtual system, and the developer does not have to know the inside of the virtual system template. By applying the same virtual system template to, for example, two physical machines pm, it is possible to operate a virtual system including a database server of a production system and a virtual system including a database server of a standby system.

However, in the virtual systems of the production system and the standby system, deployed based on the same virtual system template, it is difficult to connect a VM including a DB of a production system and a VM including a DB of a standby system and to perform replication. A reason is that while, in order to perform the replication, the two VMs are connected to each other on demand, the two VMs are deployed based the same virtual system template and each have the same private IP address accordingly. In addition, in a case where the two VMs use hardware of servers within the DC, it is difficult to change a physical configuration in such a manner as on-premises in which a system is provided within a company.

As a technology for connecting two VMs deployed based on the same virtual system template, it is conceivable that a virtual system of a standby system is established in, for example, a network of a production system. However, since this case is accompanied by a change in the virtual system template, it is difficult to apply this to a case of updating the virtual system template itself. In addition, a provider who purchases the virtual system template, thereby operating virtual systems of a production system and a standby system, does not understand a configuration of the inside of the virtual system template. Therefore, it is difficult to change the virtual system template.

In addition, as a technology for connecting the two VMs deployed based on the same virtual system template, it is conceivable that replication is performed via the production LAN 112. However, since a content of the DB of the production system is transferred via a public network, it is undesirable from a security point of view.

In addition, it is conceivable that Twice NAT is set by a host OS of the production system and a host OS of the standby system, thereby avoiding a collision of local IP addresses. However, since packets are copied at a time of rewriting an IP address, a load caused by replication increases.

Therefore, in the present embodiment, there will be described that a shared memory to serve as a storage area shared between a corresponding one of the guest OSs and a corresponding one of the host OSs is set in each of a transfer source of replication and a transfer destination thereof and a corresponding one of the host OSs transfers data of the shared memory from the transfer destination to the transfer destination via the management LAN 111.

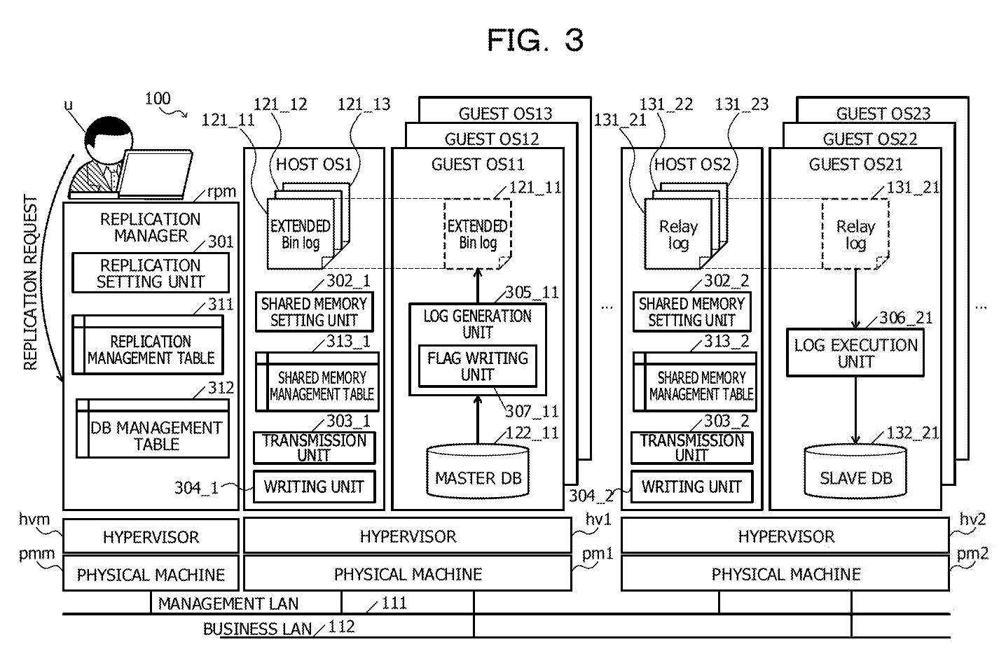

By using FIG. 1, an operation of the redundant system 100 will be described. Hypervisors hvm, hv1, and hv2 operate on the physical machines pmm, pm1, and pm2, respectively. In addition, in FIG. 1, as software to operate on the physical machine pmm, a replication manager rpm is illustrated. The replication manager rpm is software to manage the replication in the redundant system 100. The replication manager rpm may operate on one of VMs or may operate on the physical machine pmm. In a case where the replication manager rpm operates on one of VMs, a VM is created on the hypervisor hvm, and the replication manager rpm operates on the created VM. In addition, in a case where the replication manager rpm operates on the physical machine pmm, an OS operates on the physical machine pmm, and the replication manager rpm operates on the OS. A function of the replication manager rpm will be described in FIG. 3.

In addition, in FIG. 1, as pieces of software to operate on the physical machine pm1, a host OS 1 and a guest OS 11 are illustrated. In addition, in FIG. 1, as pieces of software to operate on the physical machine pm2, a host OS 2 and a guest OS 21 are illustrated. In the following description, a symbol to which “_x” is assigned indicates a symbol related to a host OS x. In the same way, a symbol to which “_xy” is assigned indicates a symbol related to a guest OS xy.

Here, in the guest OSs 11 and 21, restrictions are imposed on accesses to the management LAN 111, and it is difficult to access the management LAN 111. Accordingly, the management LAN 111 is able to perform secure communication.

Here, it is assumed that the guest OS 11 operates a DB system of a production system and the guest OS 21 operates a DB system of a standby system. In the present embodiment, as replication of data, an example of replication of a DB between the production system and the standby system will be described. In addition, in the following description, a DB to serve as a transfer source of the replication is called a “master DB”, and a DB to serve as a transfer destination of the replication is called a “slave DB”.

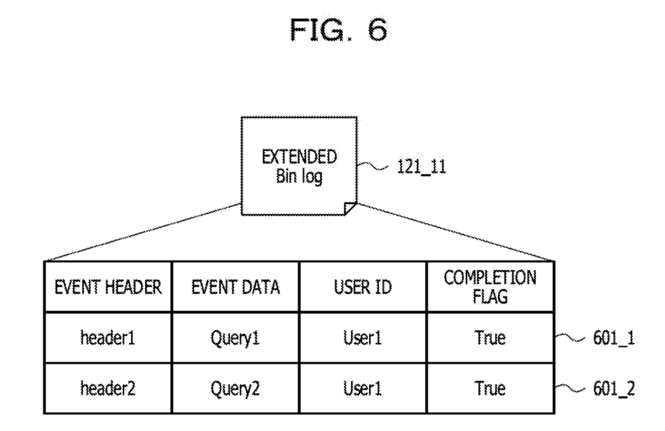

Here, replication between two DBs in MySQL will be described. A master server including the master DB stores, in a storage area called a binary log (abbreviated as a bin log, hereinafter), an update query executed for the master DB. Details of the bin log will be described in FIG. 6. Next, the master server transmits the bin log to a slave server including the slave DB. The slave server stores therein the received bin log as a relay log. In addition, based on the relay log, the slave server executes the update query for the slave DB. This causes contents of the master DB and the slave DB to become identical to each other. In the description of FIG. 1, an example in which replication of a DB in MySQL is applied will be used and described.

In the example of FIG. 1, the guest OS 11 includes an extended bin log 121_11 serving as a storage area to store therein data serving as a transfer source of replication, and a master DB 122_11. Here, the extended bin log 121 is a log in which a bin log is extended in order to secure multitenancy and atomicity of update queries. In the example of FIG. 1, the extended bin log 121_11 is mapped to a memory space of the guest OS 11 with an address of 0x11 . . . as a leading address.

In addition, the guest OS 21 includes a relay log 131_21 serving as a storage area to store therein data serving as a transfer destination of the replication, and a slave DB 132_21. In the example of FIG. 1, the relay log 131_21 is mapped to a memory space of the guest OS 21 with an address of 0x22 . . . as a leading address.

Here, as illustrated in (1) in FIG. 1, the replication manager rpm transmits, to the host OS 1 and the host OS 2, instructions 141_1 and 141_2 for the replication, respectively. The instructions for the replication each include designation of a guest OS to serve as a transfer source device to transfer data to a destination device of the replication or a transfer destination device, and information indicating a storage area corresponding to a guest OS to serve as a target of the replication. Here, the designation of the transfer source device includes information for identifying a host OS to serve as a destination device.

In the example of FIG. 1, the instruction 141_1 transmitted to the host OS 1 includes designation of the guest OS 11 as the transfer source device and the memory address of 0x11 . . . of a storage area corresponding to the guest OS 11 to serve as a target of the replication. In addition, the instruction 141_1 further includes designation of the host OS 2 as the information for identifying the destination device. In addition, the instruction 141_2 transmitted to the host OS 2 includes designation of the guest OS 21 as the transfer destination device and the memory address of 0x22 . . . of a storage area corresponding to the guest OS 21 to serve as a target of the replication.

As illustrated in (2) in FIG. 1, in response to reception of the instructions 141, the host OSs each set a storage area corresponding to the designation, in a memory shared with a corresponding one of the guests OS operating on a corresponding one of the physical machines pm on which the relevant host OS operates. The host OS 1 sets, in a shared memory for transfer, the extended bin log 121_11 starting from the memory address of 0x11 . . . , for example. Here, the extended bin logs 121 and the relay logs 131, illustrated by dotted lines in drawings subsequent to FIG. 1, each indicate a storage area shared between a corresponding one of the host OSs and a corresponding one of the guests OS. In the same way, the host OS 2 sets, in a shared memory for reception, the relay log 131_21 starting from the memory address of 0x22 . . . .

Next, as illustrated in (3) in FIG. 1, the corresponding one of the host OSs transmits, to the transfer destination device via the management LAN 111, data written into the corresponding one of the shared memories by the corresponding one of the guests OS, which is designated as the transfer source device by the corresponding one of the instructions 141 and which is managed by the relevant host OS itself. Here, the management LAN 111 is a LAN in which restrictions are imposed on accesses of the guests OS and which is used for live migration or the like. Therefore, only the host OSs are permitted to peep at the management LAN, and it is possible to perform secure communication.

In the example of FIG. 1, the guest OS 11 is designated as the transfer source device by the instruction 141_1. Therefore, the host OS 1 transmits an update query written into the extended bin log 121_11 by the guest

OS 11, to the host OS 2 to serve as the destination device, via the management LAN 111.

In addition, as illustrated in (4) in FIG. 1, the corresponding one of the host OSs writes data received via the management LAN 111, into a shared memory for reception, shared with the corresponding one of the guests OS, which is designated as the transfer destination device by the corresponding one of the instructions 141 and which is managed by the relevant host OS itself. In the example of FIG. 1, the host OS 2 writes, into the relay log 131_21, the update query received via the management LAN 111. After that, the guest OS 21 executes, for the slave DB 132_21, the update query written into the relay log 131_21.

As seen from the above, the redundant system 100 is able to efficiently perform the replication between the guest OS 11 and the guest OS 21 each having the same IP address. Specifically, the redundant system 100 transfers data by using the management LAN 111 without using the production LAN 112 and is able to perform the replication in a secure fashion accordingly. In addition, since performing no packet transformation, the redundant system 100 is able to perform the replication while not increasing a load. In addition, the redundant system 100 is able to perform the replication while not changing the virtual system template or not preparing special hardware.

Note that guests OS existing in one physical machine pm may be designated as a transfer source device and a transfer destination device of replication. In this case, a corresponding one of the host OSs may transmit data to the relevant host OS itself or may perform memory copy. A configuration for performing the memory copy will be described in a second embodiment. In addition, a guest OS existing in one physical machine pm may be designated as a transfer source device or a transfer destination device of a replication operation and may be designated as a transfer source device or a transfer destination device of another replication operation. In this case, one of the master DBs 122 and one of the slave DBs 132 are mixed in one physical machine pm in some cases. A configuration in a case where one of the master DBs 122 and one of the slave DBs 132 are mixed in one physical machine pm will be described in a third embodiment.

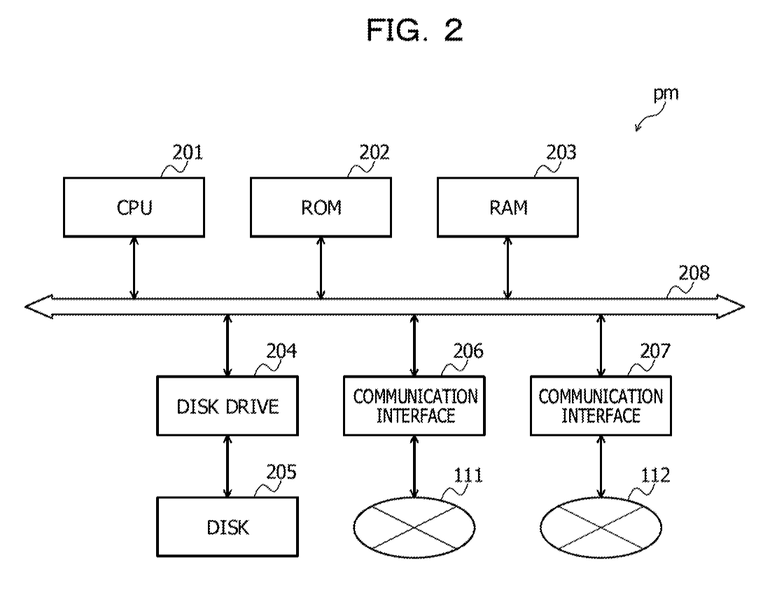

In addition, while, in the above-mentioned explanation, an example in which the present embodiment is applied to a system to which a hypervisor type is applied is described as a technology for providing the virtual machine architecture, there is no limitation to this. The present embodiment may be applied to, for example, a system to which a host type is applied and which causes a VM to operate as one application of a host OS. Next, hardware configurations of the physical machines pmm, pm1, and pm2 will be described by using FIG. 2.

FIG. 2 is an explanatory diagram illustrating an example of a hardware configuration of a physical machine. Since being identical to each other, all pieces of hardware included in the physical machines pmm, pm1, and pm2 will be each simply described as a physical machine pm in the explanation of FIG. 2. In FIG. 2, the physical machine pm includes a central processing unit (CPU) 201, a read-only memory (ROM) 202, and a random-access memory (RAM) 203. In addition, the physical machine pm further includes a disk drive 204, a disk 205, and communication interfaces 206 and 207. In addition, the CPU 201 to the disk drive 204 and the communication interfaces 206 and 207 are connected to one another via a bus 208.

The CPU 201 is an arithmetic processing device to manage control of the entire physical machine pm. In addition, the physical machine may include CPUs. The ROM 202 is a nonvolatile memory to store therein a program such as a boot program. The RAM 203 is a volatile memory used as a work area of the CPU 201.

The disk drive 204 is a control device to control reading and writing of data from and to the disk 205 in accordance with control from the CPU 201. A magnetic disk drive, an optical disk drive, a solid state drive, or the like may be adopted as the disk drive 204, for example. The disk 205 is a nonvolatile memory to store therein data written by control from the disk drive 204. In a case where the disk drive 204 is, for example, a magnetic disk drive, a magnetic disk may be adopted as the disk 205. In addition, in a case where the disk drive 204 is an optical disk drive, an optical disk may be adopted as the disk 205. In addition, in a case where the disk drive 204 is a solid state drive, a semiconductor memory formed by semiconductor elements, a so-called semiconductor disk, may be adopted as the disk 205.

Each of the communication interfaces 206 and 207 is a control device that manages an interface between a network and the inside and that controls inputs and outputs of data from and to other devices. Specifically, the communication interface 206 is connected to other devices via the management LAN 111. In addition, the communication interface 207 is connected to other devices via the production LAN 112. A modem, a LAN adapter, or the like may be adopted as each of the communication interfaces 206 and 207, for example.

In addition, in a case where an administrator of the redundant system 100 directly operates physical machines, the physical machines pm may each include pieces of hardware such as a display, a keyboard, and a mouse. Note that since the physical machine pmm is not connected to the production LAN 112, the communication interface 207 may be omitted.

Example of Functional Configuration of Redundant System 100

FIG. 3 is an explanatory diagram illustrating an example of a functional configuration of the redundant system 100. The redundant system 100 includes a replication setting unit 301, shared memory setting units 302, transmission units 303, writing units 304, log generation units 305, and log execution units 306. Here, the replication setting unit 301 is a function included in the replication manager rpm in the physical machine pmm. The shared memory setting units 302 to the writing units 304 are functions included in the host OSs to operate on the respective physical machines pm1 and pm2. Each of the log generation units 305 is a function included in an OS that is included in the guest OSs operating on the physical machines pm1 and pm2 and that includes a corresponding one of the master DBs 122. In addition, the log generation units 305 each include a flag writing unit 307. Each of the log execution units 306 is a function included in an OS that is included in the guest OSs operating on the physical machines pm1 and pm2 and that includes a corresponding one of the slave DBs 132.

Here, in the example of FIG. 3, the physical machine pm1 causes guest OSs 12 and 13 to operate in addition to the host OS 1 and the guest OS 11. While not illustrated in FIG. 3, the guest OSs 12 and 13 each include one of the extended bin logs 121, one of the master DBs 122, and one of the log generation units 305. In the same way, the physical machine pm2 causes guest OSs 22 and 23 to operate in addition to the host OS 2 and the guest OS 21. While not illustrated in FIG. 3, the guest OSs 22 and 23 each include one of the relay logs 131, one of the slave DBs 132, and one of the log execution units 306.

In addition, in the first embodiment, it is assumed that, as illustrated in FIG. 3, the host OS 1 includes the extended bin logs 121 to be shared and the host OS 2 includes the relay logs 131 to be shared. The host OSs each include one of the extended bin logs 121 or one of the relay logs 131 for each of the guest OSs. In the example of FIG. 3, the host OS 1 includes the extended bin log 121_11 of the guest OS 11, an extended bin log 121_12 of the guest OS 12, and an extended bin log 121_13 of the guest OS 13. In addition, the host OS 2 includes the relay log 131_21 of the guest OS 21, a relay log 131_22 of the guest OS 22, and a relay log 131_23 of the guest OS 23.

In addition, the replication manager rpm is able to access a replication management table 311 and a DB management table 312. The replication management table 311 and the DB management table 312 are stored in storage devices such as the RAM 203 and the disk 205 in the physical machine pmm.

In addition, the hosts OS are able to access the shared memory management tables 313. The shared memory management tables 313 are stored in storage devices such as the RAMs 203 and the disks 205 in the physical machines pm1 and pm2.

In response to reception of a replication request from a terminal operated by a user u who instructs to perform replication, the replication setting unit 301 performs a setting of the replication. A set content is stored in the replication setting unit 301.

In response to reception of a corresponding one of the instructions 141 from the physical machine pmm, a corresponding one of the shared memory setting units 302 sets a shared memory corresponding to designation included in the relevant instruction 141, in a shared memory shared with a corresponding one of the guests OS operating on a corresponding one of the physical machines pm. Specifically, in a case where one of the guest OSs managed by the corresponding one of the shared memory setting units 302 itself is designated as a transfer source device by the corresponding one of the instructions 141, the relevant shared memory setting unit 302 sets a shared memory corresponding to designation included in the relevant instruction 141, in a shared memory for transfer, shared with the relevant guest OS. In addition, in a case where one of the guest OSs managed by a corresponding one of the shared memory setting units 302 itself is designated as a transfer designation device by a corresponding one of the instructions 141, the relevant shared memory setting unit 302 sets a shared memory corresponding to designation included in the relevant instruction 141, in a shared memory for reception, shared with the relevant guest OS. Information of the set shared memory is stored in the corresponding one of the shared memory management tables 313.

In a case where one of the guest OSs managed by a corresponding one of the transmission units 303 itself is designated as a transfer source device by a corresponding one of the instructions 141, the relevant transmission unit 303 transmits, to a destination device via the management LAN 111, data written into a shared memory for transfer by the corresponding one of the guest OSs. Specifically, in the example of FIG. 3, the guest OS 11 managed by the host OS 1 is designated as the transfer source device by the instruction 141_1, and the host OS 2 is designated as a destination device. In this case, in response to writing of an entire update query into the extended bin log 121_11, the update query being executed for the master DB 122_11, the transmission unit 303_1 transmits the entire update query to the host OS 2 via the management LAN 111. Here, in a case of transmitting a portion of the update query, there is a possibility that a corresponding one of the slaves DB 132 is destroyed. Accordingly, in the present embodiment, in order to assure transmission of the entire update query, a corresponding one of the flag writing units 307 monitors writing into a corresponding one of the extended bin logs 121.

In a case where a corresponding one of the guests OS managed by a corresponding one of the writing units 304 itself is designated as the transfer destination device by a corresponding one of the instructions 141, the relevant writing unit 304 writes, into a shared memory for reception, data received via the management LAN 111. Specifically, in the example of FIG. 3, the guest OS 11 is designated as the transfer source device by the instruction 141_1, and the guest OS 21 managed by the host OS 2 is designated as the transfer destination device by the instruction 141_2. In this case, the writing unit 304_2 writes, into the relay log 131_21, data received via the management LAN 111.

In the following description in FIG. 3, an example of a function in a case where information for identifying a user who instructs to perform replication is included in a corresponding one of the instructions 141 will be described. The information for identifying a user may be any kind of information capable of uniquely identifying a user and is, for example, a user identification (ID). Hereinafter, it is assumed that the information for identifying a user is the user ID.

In response to reception of the corresponding one of the instructions 141 from the physical machine pmm, a corresponding one of the shared memory setting units 302 sets a shared memory of an OS of a user, the OS of the user being included in OSs operating on the physical machine pm of the relevant shared memory setting unit 302 itself. In the example of, for example, FIG. 3, it is assumed that the OS of the user u is the guest OS 11 out of the guest OS 11 to guest OS 13. In this case, the corresponding one of the shared memory setting units 302 sets, as a shared memory for transfer, the extended bin log 121_11 to serve as a shared memory of the guest OS 11.

In addition, in a case where one of the guest OSs managed by the corresponding one of the transmission units 303 itself is designated as the transfer source device by the corresponding one of the instructions 141, the relevant transmission unit 303 transmits, to the destination device via the management LAN 111, data and a user ID, written into the shared memory for transfer by the relevant guest OS. The transmission unit 303_1 transmits an entry of the extended bin log 121_11 and the user ID of the user u to the host OS 2 via the management LAN 111, for example.

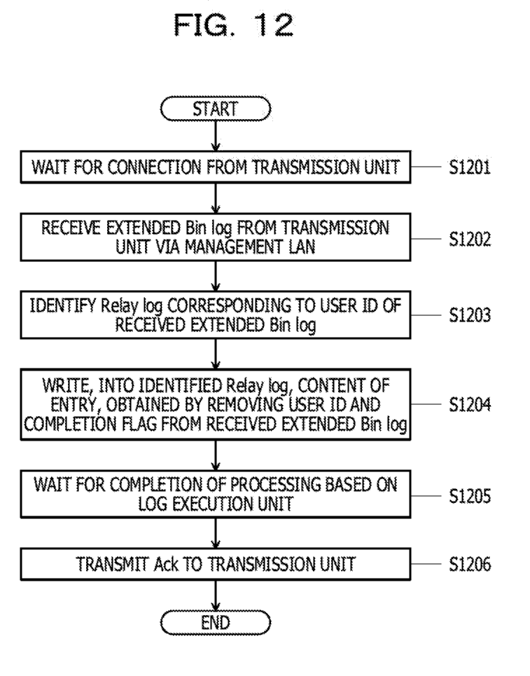

In addition, in a case where one of the guest OSs managed by the corresponding one of the writing units 304 itself is designated as the transfer destination device by the corresponding one of the instructions 141, the relevant writing unit 304 writes data received via the management LAN 111, into a shared memory for reception of the relevant guest OS identified from among OSs by the received user ID. It is assumed that the host OS 2 receives, via the management LAN 111, an entry of the extended bin log 121_11 and the user ID of the user u, for example. In addition, it is assumed that the OS of the user u is the guest OS 21 out of the guest OS 21 to guest OS 23. In this case, the writing unit 304_2 writes the entry of the extended bin log 121_11 into the relay log 131_21. Note that data written at this time is a portion other than extended information of the extended bin log 121_11. Specific processing for writing will be described in FIG. 12.

A corresponding one of the log generation units 305 writes, into the corresponding one of the extended bin logs 121, an update query executed for the corresponding one of the master DBs 122. The update query is, for example, an INSERT statement, an UPDATE statement, a DELETE statement, or the like.

A corresponding one of the log execution units 306 executes, for the corresponding one of the slave DBs 132, an update query written into the corresponding one of the relay logs 131.

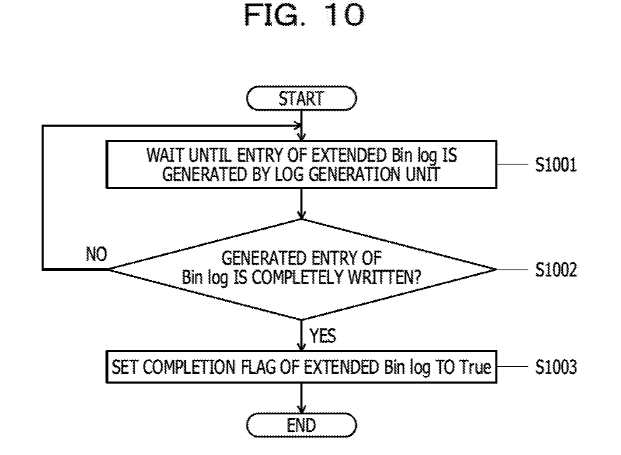

In order to assure atomicity of an update query, a corresponding one of the flag writing units 307 monitors writing into the corresponding one of the extended bin logs 121, and in a case of finishing writing an entire entry of the relevant extended bin log 121, the relevant flag writing unit 307 writes a flag indicating completion of writing of the entire entry. Specific processing will be described in FIG. 10.

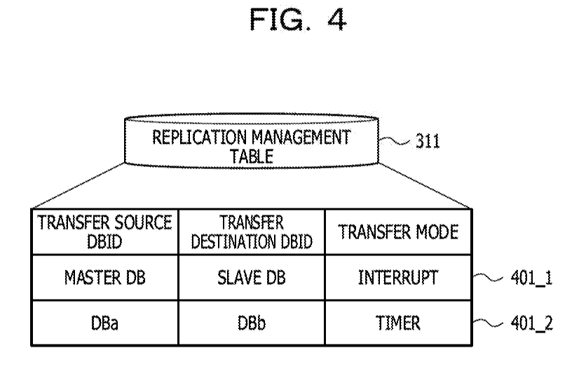

FIG. 4 is an explanatory diagram illustrating an example of a storage content of the replication management table 311. The replication management table 311 is a table for managing a combination of a transfer source and a transfer destination of a DB serving as a replication target. In addition, an entry of the replication management table 311 is generated at a time of receiving an instruction to perform replication. The replication management table 311 illustrated in FIG. 4 includes entries 401_1 and 401_2.

The replication management table 311 includes fields of a transfer source DBID, a transfer destination DBID, and a transfer mode. In the transfer source DBID field, information for identifying a DB to serve as a transfer source of replication is stored. In the transfer destination DBID field, information for identifying a DB to serve as a transfer destination of replication is stored. In the transfer mode field, information for identifying a transfer mode for transferring data is stored. Specifically, transfer modes include “interrupt” serving as a mode in which writing into a corresponding one of the master DBs is detected by an interrupt and written data is transferred to a corresponding one of the slave DBs, and “timer” serving as a mode in which data of a transfer source DB is transferred to a transfer destination DB at regular intervals.

The entry 401_1 indicates that a transfer source DB is a corresponding one of the master DBs 122, a transfer destination DB is a corresponding one of the slave DBs 132, and the transfer mode is “interrupt”, for example.

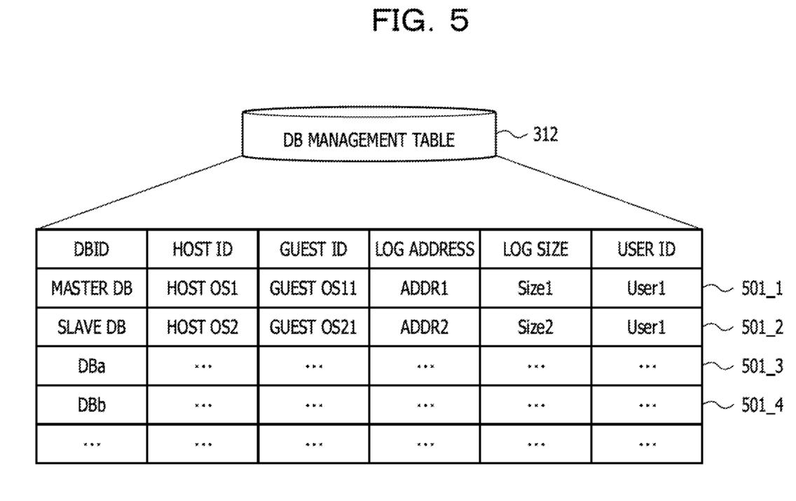

FIG. 5 is an explanatory diagram illustrating an example of a storage content of the DB management table 312. The DB management table 312 is a table for individually managing DBs to serve as replication targets. One of entries of the DB management table 312 corresponds to one of DBs. In addition, entries of the DB management table 312 are generated at a time of deploying DBs. The DB management table 312 illustrated in FIG. 5 includes entries 501_1 to 501_4.

The DB management table 312 includes fields of a DBID, a host ID, a guest ID, a log address, a log size, and a user ID. In the DBID field, information for identifying DBs is stored. In the host ID field, information for identifying host OSs to manage guest OSs each including a DB is stored. In the guest ID field, information for identifying the guest OSs each including a DB is stored. In the log address field, memory addresses of logs on the guest OSs are stored. In addition, along therewith, information indicating types of DB may be stored in the log address field. In the log size field, sizes of logs are stored. In the user ID field, information for identifying users who each instruct to perform replication is stored.

The entry 501_1 is an entry related to a corresponding one of the master DBs 122, used for replication, for example. In addition, the entry 501_1 indicates that an address of the extended bin log 121 to serve as a log on the guest OS 11 is ADDR1, a size of the relevant extended bin log 121 is Size1, and a user who instructs to perform replication is User1.

FIG. 6 is an explanatory diagram illustrating an example of storage contents of the extended bin logs 121. Each of the extended bin logs is a log obtained by extending a bin log. The extended bin log 121_11 illustrated in FIG. 6 includes entries 601_1 and 601_2.

The extended bin logs 121 each include fields of an event header, event data, a user ID, and a completion flag. The event header field and the event data field are fields included in a bin log before extension. Specifically, in the event header field, a time stamp and a type of an update request are stored. In addition, in the event data field, a content of Query is stored.

In the user ID field, information for identifying users for multitenancy is stored. A reason why the user ID field is added is that in general VMs are deployed on a physical machine and a DB of a different user is deployed in each of the VMs. Therefore, in order to adequately separate users, thereby performing replication, a bin log is extended, and user IDs are written thereinto in such a manner as the present embodiment. Accordingly, it is possible for a corresponding one of the writing units 304 to identify the relay logs 131 corresponding to the respective user IDs.

In the completion flag field, information indicating whether or not generation of entries of a bin log is completed is stored. Specifically, in the completion flag field, “True” indicating that generation of entries of a bin log is completed or “False” indicating that generation of entries of a bin log is not completed is stored. In the completion flag field, “False” is stored as an initial value.

A reason why the completion flag field is added is that in a case where entries of a bin log are generated based on an update request, if entries of a bin log in a partially generated state are only reflected in the corresponding one of the slave DBs 132, there is a possibility that the relevant slave DB 132 is destroyed. Therefore, when the update request is written by a corresponding one of the log generation units 305, the completion flag of the bin log is set to “True” , thereby enabling the atomicity of the update request to be secured.

The entry 601_1 indicates that generation of entries for an update request for a DB of User1 is completed, for example.

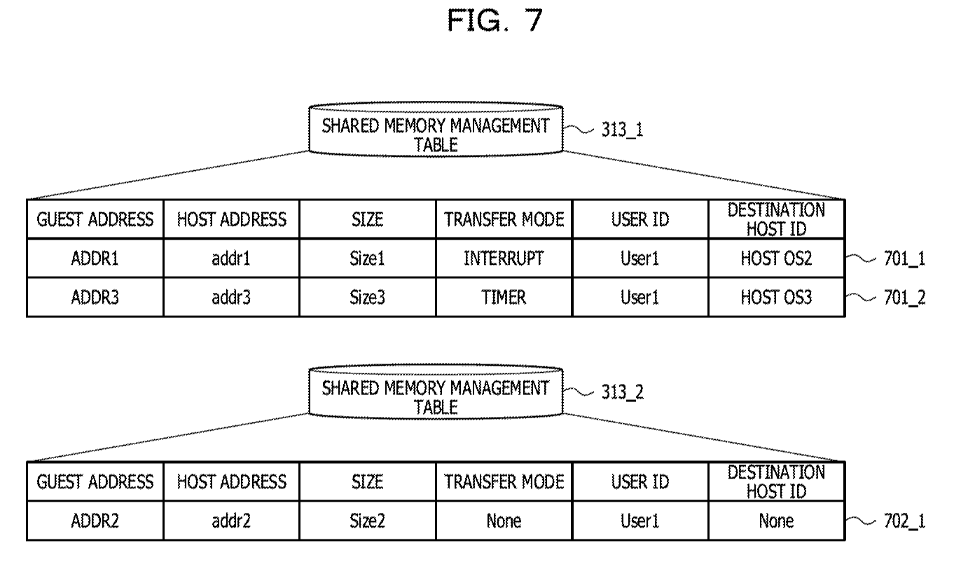

FIG. 7 is an explanatory diagram illustrating examples of storage contents of the shared memory management tables 313. Each of the shared memory management tables 313 is a table for managing a log set in a shared memory. In addition, entries of each of the shared memory management tables 313 are generated in a case of receiving an instruction to set a shared memory from the replication manager rpm. The shared memory management table 313_1 illustrated in FIG. 7 includes entries 701_1 and 701_2. In addition, the shared memory management table 313_2 illustrated in FIG. 7 includes an entry 702_1.

The shared memory management tables 313 each include fields of a guest address, a host address, a size, a transfer mode, a user ID, and a destination host ID. Among these, the guest address field, the size, the transfer mode, and the user ID are values given notice of by the replication manager rpm. In addition, in the guest address field, the size, and the user ID, the same values as those of the respective fields of the log address, the log size, and the user ID of the DB management table 312 are stored. In addition, in a case where the physical machine pm including a corresponding one of the shared memory management tables 313 is on a transfer source side, the same value as that of the transfer mode field of the replication management table 311 is stored in the transfer mode field. On the other hand, in a case where the physical machine pm including a corresponding one of the shared memory management tables 313 is on a transfer destination side, the transfer mode field is set to “None”.

In the host address field, a memory address of a log on a host OS is stored, the log being set in a shared memory. In a case where the physical machine pm including a corresponding one of the shared memory management tables 313 is on a transfer source side, information for identifying a host on a transfer destination side is stored in the destination host ID field. On the other hand, in a case where the physical machine pm including a corresponding one of the shared memory management tables 313 is on a transfer destination side, the destination host ID field is set to “None”.

As described above, each of the fields of the transfer mode and the destination host ID is a field used only by the transfer source side. Therefore, each of the host OSs is able to identify that an entry set to “None” is an entry to serve as a transfer destination.

The entry 701_1 is a setting of the extended bin log 121_11 illustrated in FIG. 3, for example. Specifically, the entry 701_1 indicates that the extended bin log 121_11 having the user ID of User1, the host address of addr1, and the size of Size1 is to be transferred to the host OS 2 by using an interrupt.

In addition, the entry 702_1 is a setting of the relay log 131_21 illustrated in FIG. 3. Specifically, the entry 702_1 indicates that an entry of the extended bin log 121_11 received from the transfer source side is to be written into the relay log 131_21 having the user ID of User1, the host address of addr2, and the size of Size2.

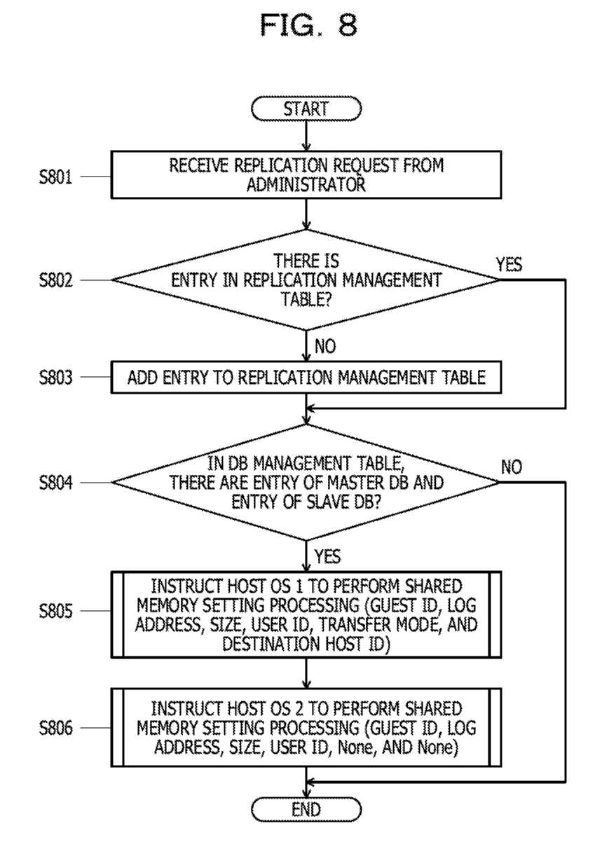

Next, processing performed by the redundant system 100 will be described by using FIG. 8 to FIG. 12.

FIG. 8 is a flowchart illustrating an example of a replication setting processing procedure. Replication setting processing is processing for setting replication. The replication setting processing is processing for realizing functions included in the replication setting unit 301 and is processing performed by the replication manager rpm.

The replication manager rpm receives a replication request from an administrator (step S801). Here, the replication request includes DBID to serve a master DB, DBID to serve a slave DB, and a transfer mode.

Next, the replication manager rpm determines whether or not there is an entry in the replication management table 311 (step S802). Note that an initial state is a state in which there is no entry in the replication management table 311. In a case where there is no entry in the replication management table 311 (step S802: No), the replication manager rpm adds an entry to the replication management table 311 (step S803).

After step S803 finishes or in a case where there is an entry in the replication management table 311 (step S802: Yes), the replication manager rpm determines whether or not, in the DB management table 312, there are an entry of one of the master DBs 122 and an entry of one of the slave DBs 132 (step S804). In a case where there are the above-mentioned two entries (step S804: Yes), the replication manager rpm transmits, to the host OS 1, an instruction to perform shared memory setting processing having arguments of a guest ID, a log address, a size, a user ID, a transfer mode, and a destination host ID (step S805). In addition, the replication manager rpm transmits, to the host OS 2, an instruction to perform shared memory setting processing having arguments of a guest ID, a log address, a size, the user ID, None, and None (step S806). After step S806 finishes, the replication manager rpm terminates the replication setting processing.

On the other hand, in a case where, in the DB management table 312, there is no entry of the master DBs 122 or there is no entry of the slave DBs 132 (step S804: No), the replication manager rpm terminates the replication setting processing with an error. By performing the replication setting processing, the replication manager rpm is able to perform a setting of replication within the redundant system 100.

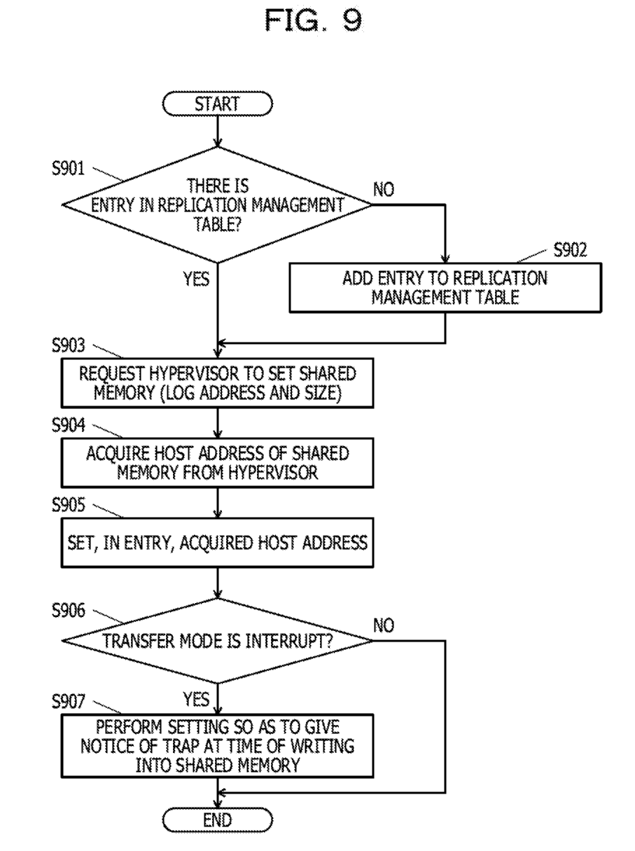

FIG. 9 is a flowchart illustrating an example of a shared memory setting processing procedure. Shared memory setting processing is processing for setting a shared memory. The shared memory setting processing is processing for realizing functions included in each of the shared memory setting units 302 and is processing performed by a corresponding one of the host OSs. In addition, the shared memory setting processing receives, as arguments, a guest ID, a log address, a size, a user ID, a transfer mode, and a destination host ID.

The corresponding one of the hosts OS determines whether or not there is an entry in the replication management table 311 (step S901). In a case where there is no entry in the replication management table 311 (step S901:

No), the corresponding one of the host OSs adds an entry to the replication management table 311 (step S902). At this time, contents of the added entry are the log address, the size, the user ID, the transfer mode, and the destination host ID, obtained as the arguments. At this stage, the host address field of the added entry is blank.

After the processing operation in step S902 finishes or in a case where there is an entry in the replication management table 311 (step S901: Yes), the corresponding one of the host OSs issues, to a corresponding one of the hypervisors hv, a request to set a shared memory having arguments of the log address and the size (step S903). In addition, the corresponding one of the host OSs acquires, from the corresponding one of the hypervisors hv, a host address of the shared memory (step S904). Next, the corresponding one of the host OS sets, in the entry, the acquired host address (step S905). In addition, the corresponding one of the host OSs determines whether or not the transfer mode is the interrupt (step S906). In a case where the transfer mode is the interrupt (step S906: Yes), the corresponding one of the host OSs performs a setting so as to give notice of a trap at a time of writing into the shared memory (step S907). After the processing operation in step S907 finishes, the corresponding one of the host OSs terminates the shared memory setting processing.

On the other hand, in a case where the transfer mode is not the interrupt (step S906: No), in other words, in a case where the transfer mode is the timer or None, the corresponding one of the host OSs terminates the shared memory setting processing. By performing the shared memory setting processing, the corresponding one of the host OSs is able to set the shared memory.

Here, examples of a transfer source and a transfer destination in a case where the shared memory setting processing is performed will be described. The host OS 1 that manages one of the guest OSs, designated as a transfer source device, performs the shared memory setting processing, thereby generating the entry 701_1 illustrated in FIG. 7 and setting the extended bin log 121_11 in a shared memory for transfer. In addition, the host OS 2 that manages one of the guest OSs, designated as a transfer destination device, performs the shared memory setting processing, thereby generating the entry 702_1 illustrated in FIG. 7 and setting the relay log 131_21 in a shared memory for reception.

FIG. 10 is a flowchart illustrating an example of a flag writing processing procedure. Flag writing processing is processing for writing a completion flag of each of the extended bin logs 121. The flag writing processing is processing for realizing functions included in each of the flag writing units 307 and is processing performed by a corresponding one of the guest OSs.

The corresponding one of the guest OSs waits until an entry of a corresponding one of the extended bin logs is generated by a corresponding one of the log generation units 305 (step S1001). Next, the corresponding one of the guest OSs determines whether or not the generated entry of the corresponding one of the bin logs is completely written (step S1002). In a case where the generated entry of the corresponding one of the bin logs is not completely written (step S1002: No), the corresponding one of the guest OSs makes a transition to the processing operation in step S1001. On the other hand, in a case where the generated entry of the corresponding one of the bin logs is completely written (step S1002: Yes), the corresponding one of the guest OSs sets the completion flag of the corresponding one of the extended bin logs to True (step S1003). After the processing operation in step S1003 finishes, the corresponding one of the guest OSs terminates the flag writing processing. By performing the flag writing processing, the corresponding one of the guest OSs is able to secure atomicity of an update request.

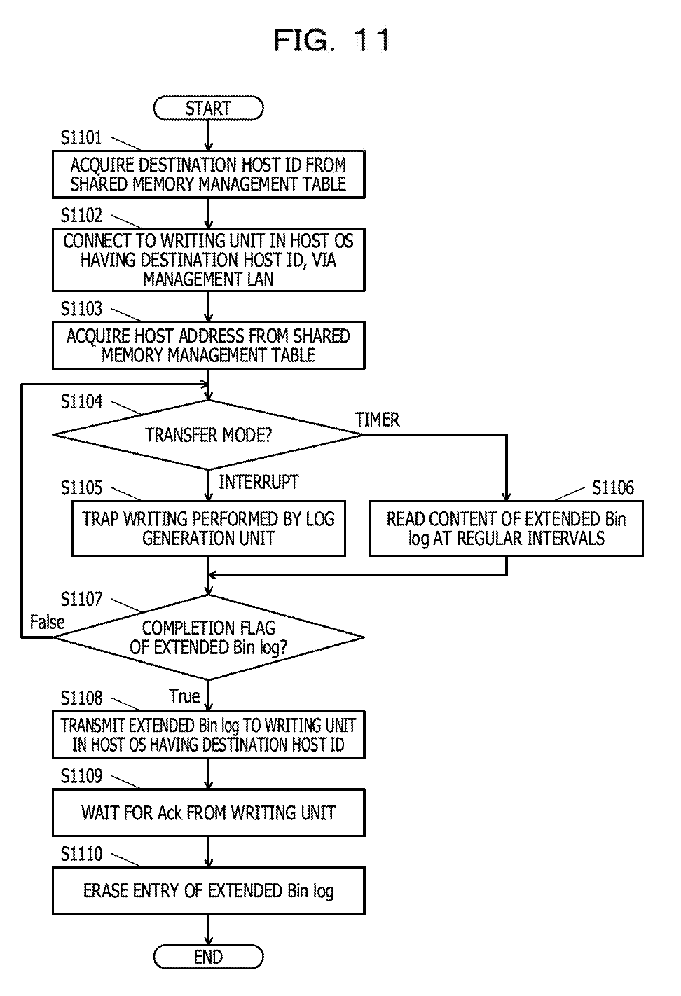

FIG. 11 is a flowchart illustrating an example of a log transmission processing procedure. Log transmission processing is processing for transmitting a log. The log transmission processing is processing for realizing functions included in each of the transmission units 303 and is processing performed by a corresponding one of the host OSs.

The corresponding one of the host OSs acquires a destination host ID from a corresponding one of the shared memory management tables 313 (step S1101). Next, the corresponding one of the host OSs connects to the writing unit 304 in one of the host OSs, the relevant host OS having the destination host ID, via the management LAN 111 (step S1102). In addition, the corresponding one of the host OSs acquires a host address from the corresponding one of the shared memory management tables 313 (step S1103). Next, the corresponding one of the host OSs confirms the transfer mode (step S1104). In a case where the transfer mode is the interrupt (step S1104: Interrupt), the corresponding one of the host OSs traps writing performed by a corresponding one of the log generation units 305 (step S1105). On the other hand, in a case where the transfer mode is the timer (step S1104: Timer), the corresponding one of the host OSs reads a content of a corresponding one of the extended bin logs 121 at regular intervals (step S1106).

After the processing operation in step S1105 or step S1106 finishes, the corresponding one of the host OSs confirms the completion flag of the corresponding one of the extended bin logs 121 (step S1107). In a case where the completion flag of the corresponding one of the extended bin logs 121 is False (step S1107: False), the corresponding one of the host OSs makes a transition to the processing operation in step S1104. On the other hand, in a case where the completion flag of the corresponding one of the extended bin logs 121 is True (step S1107: True), the corresponding one of the host OSs transmits the corresponding one of the extended bin logs 121 to the writing unit 304 in one of the host OSs, the relevant host OS having the destination host ID (step S1108). Next, the corresponding one of the host OSs waits for Ack from the corresponding one of the writing units 304 (step S1109). After receiving Ack, the corresponding one of the host OSs erases an entry of the corresponding one of the extended bin logs 121 (step S1110). After the processing operation in step S1110 finishers, the corresponding one of the host OSs terminates the log transmission processing. By performing the log transmission processing, the host OS serving as the transfer source is able to transmit, to the transfer destination, data written into a corresponding one of the master DBs 122.

FIG. 12 is a flowchart illustrating an example of a log writing processing procedure. Log writing processing is processing for receiving and writing a log into a corresponding one of the relay logs 131. The log writing processing is processing for realizing functions included in each of the writing units 304 and is processing performed by a corresponding one of the host OSs.

The corresponding one of the host OSs waits for a connection from a corresponding one of the transmission units 303 (step S1201). In a case where a connection from the corresponding one of the transmission units 303 is established, the corresponding one of the host OSs receives a corresponding one of the extended bin logs 121 from the relevant transmission unit 303 via the management LAN 111 (step S1202). Next, the corresponding one of the host OSs identifies the relay log 131 corresponding to a user ID of the received extended bin log 121 (step S1203). In addition, the corresponding one of the host OSs writes, into the identified relay log 131, a content of an entry, obtained by removing the user ID and the completion flag from the received extended bin log 121 (step S1204). Next, the corresponding one of the host OSs waits for completion of processing based on a corresponding one of the log execution units 306 (step S1205). After the corresponding one of the log execution units 306 completes the processing, the corresponding one of the host OSs transmits Ack to the corresponding one of the transmission units 303 (step S1206).

After the processing operation in step S1206 finishes, the corresponding one of the host OSs terminates the log writing processing. By performing the log writing processing, the corresponding one of the host OSs is able to receive, from a transfer source, data written into a corresponding one of the master DBs 122.

As described above, in the redundant system 100, a shared memory between a guest OS and a host OS is set in each of the transfer source and the transfer destination of replication, and the host OS serving as the transfer source transfers data of a corresponding one of the shared memories to the transfer destination via the management LAN 111. Accordingly, in the redundant system 100, it is possible to efficiently perform replication between the guest OS 11 and the guest OS 21 each having the same IP address. Specifically, the redundant system 100 transfers data by using the management LAN 111 without using the production LAN 112 and is able to perform replication in a secure fashion accordingly. In addition, since performing no packet transformation, the redundant system 100 is able to perform replication while not increasing a load. In addition, the redundant system 100 is able to perform replication while not changing the virtual system template or not preparing special hardware.

In addition, in the redundant system 100, shared memories of guest OSs of a user identified by a user ID included in the corresponding one of the instructions 141 may be set, the transfer source may transmit data and the user ID of a corresponding one of the shared memories, and the transfer destination may write the received data into the shared memory of the received user ID. This enables the redundant system 100 to be compatible with the multitenancy. On the other hand, in the redundant system 100, in a case where it is preliminarily understood that the number of users who each instruct to perform replication is one, the user ID field does not have to be provided in each of the extended bin logs 121, the DB management tables 312, and the shared memory management tables 313.

In addition, in the redundant system 100, in response to writing of an entire update query into a shared memory between guest OSs of the transfer source, the update query being executed for a corresponding one of the master DBs 122, the entire update query may be transmitted to the host OS serving as the transfer destination, via the management LAN 111. This enables the atomicity of the update query to be assured and enables a corresponding one of the slave DBs 132 to be inhibited from being destroyed.

In addition, IP addresses of guest OSs included in the redundant system 100 may be set by the virtual system template. In the redundant system 100, by applying the virtual system template, it is possible to efficiently perform replication between guest OSs each having the same IP address. In addition, even in an example in which the virtual system template is not applied, the present embodiment may be applied. This is, for example, a case where, in order to facilitate management, a user who manages replication uniforms a network configuration of a virtual system of a production system and a network configuration of a virtual system of a standby system. Even in this case, it is possible to efficiently perform replication between guest OSs that belong to respective different virtual systems and that each have the same IP address.

### Description of Second Embodiment

A redundant system according to a second embodiment is a system compatible with a case where a configuration, in which a guest OS including a master DB and a guest OS including a slave DB operate on the same physical machine, and a configuration, in which a guest OS including a master DB and a guest OS including a slave DB operate on respective different physical machines, are mixed. In such a case, the redundant system according to the second embodiment determines the two configurations and properly uses copying between memories and transfer via the management LAN 111. The same symbols are assigned to parts similar to respective parts described in the first embodiment, and the illustrations and descriptions thereof will be omitted.

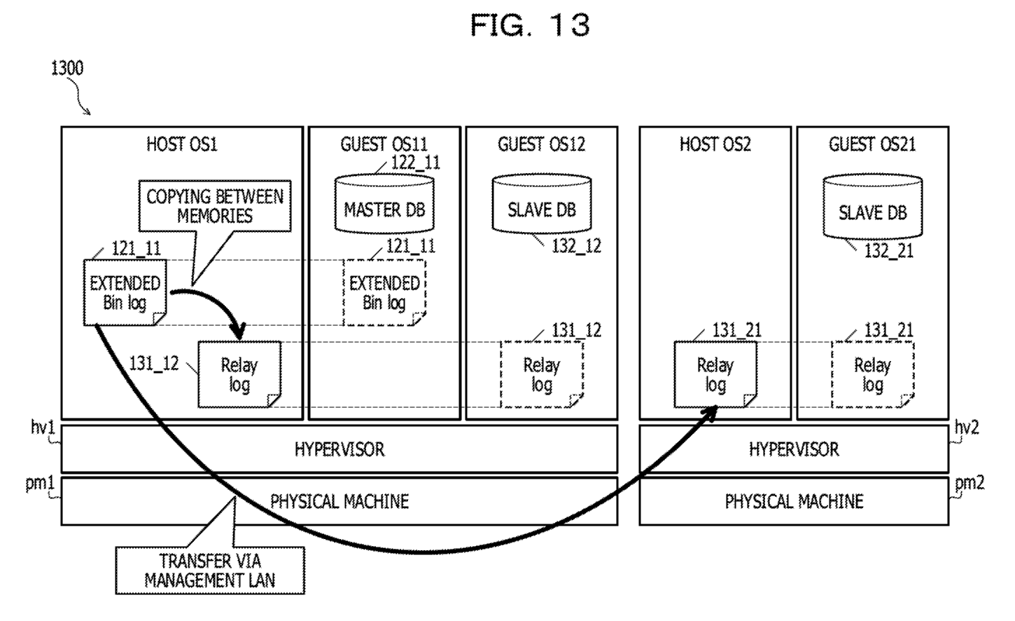

FIG. 13 is an explanatory diagram illustrating an example of an operation of a redundant system 1300 according to the second embodiment. In the redundant system 1300 illustrated in FIG. 13, the physical machine pm1 causes the host OS 1, the guest OS 11, and the guest OS 12 to operate. In addition, the physical machine pm2 causes the host OS 2 and the guest OS 21 to operate. Note that while not illustrated in FIG. 13, the physical machine pmm exists within the redundant system 1300.

Based on an update request received from a client serving as a user of the guest OS 11, the guest OS 11 generates an entry of the extended bin log 121_11. Upon detecting writing into the extended bin log 121_11, the host OS 1 compares a destination host ID and an ID of the host OS 1 itself with each other.

It is assumed that the destination host ID and the ID of the host OS 1 itself are identical to each other, in other words, a slave DB corresponding to the master DB 122_11 is a slave DB 132_12 in the example of FIG. 13. In this case, the host OS 1 copies, to the relay log 131_12, data written into the extended bin log 121_11. In addition, the guest OS 12 executes an SQL copied to the relay log 131_12, thereby reflecting in the slave DB 132_12.

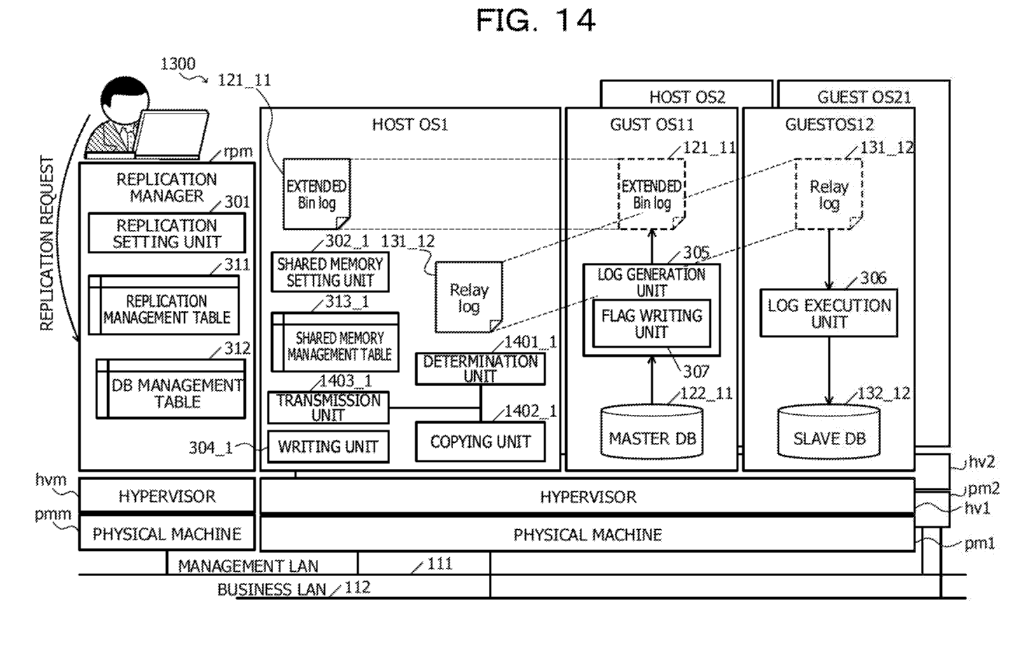

On the other hand, in the example of FIG. 13, it is assumed that the destination host ID and the ID of the host OS 1 itself are different from each other, in other words, a slave DB corresponding to the master DB 122_11 is the slave DB 132_21. In this case, the host OS 1 transmits, to the host OS 2 via the management LAN 111, data written into the extended bin log 121_11. The host OS 2 writes the received data into the relay log 131_21. In addition, the guest OS 21 executes an SQL copied to the relay log 131_21, thereby reflecting in the slave DB 132_21. Next, an example of a functional configuration of the redundant system 1300 will be described by using FIG. 14.

FIG. 14 is an explanatory diagram illustrating an example of the functional configuration of the redundant system 1300. The redundant system 1300 includes the replication setting unit 301, the shared memory setting units 302, the writing units 304, the log generation unit 305, the log execution units 306, determination units 1401, copying units 1402, and transmission units 1403. Here, the shared memory setting unit 302, the writing unit 304, and the determination unit 1401 to the transmission unit 1403 are functions included in each of the host OSs that operate on the respective physical machines pm1 and pm2.

Here, in the example of FIG. 14, the physical machine pm1 causes the host OS 1 and the guest OSs 11 and 12 to operate. In addition, the guest OS 11 includes the master DB 122_11, and the guest OS 12 includes the slave DB 132_12. In addition, the physical machine pm2 causes the host OS 2 and the guest OS 21 to operate.

In the example of FIG. 14, it is assumed that the host OS 1 includes the extended bin log 121_11 to be shared and a relay log 131_12 to be shared.

In a case of receiving an update request, a corresponding one of the determination units 1401 determines whether a DB to serve as a transfer destination and a DB to serve as a transfer source are deployed on the same physical machine or are deployed on respective different physical servers.

In a case where the corresponding one of the determination units 1401 determines that the DB to serve as a transfer destination is deployed on the same physical machine as that of the DB to serve as a transfer source, a corresponding one of the copying units 1402 copies, to a shared memory for reception, data written into a shared memory for transfer. It is assumed that the determination unit 1401_1 determines that the DB to serve as a transfer destination is deployed on the same physical machine as that of the DB to serve as a transfer source, for example. In this case, the copying unit 1402_1 copies, to the relay log 131 serving as the shared memory for reception, an entry of the extended bin log 121_11 serving as the shared memory for transfer.

In a case where the corresponding one of the determination units 1401 determines that the DB to serve as the transfer destination is deployed on a physical server different from that of the DB to serve as the transfer source, the corresponding one of the copying units 1402 transmits, to a destination device via the management LAN 111, data written into the shared memory for transfer.

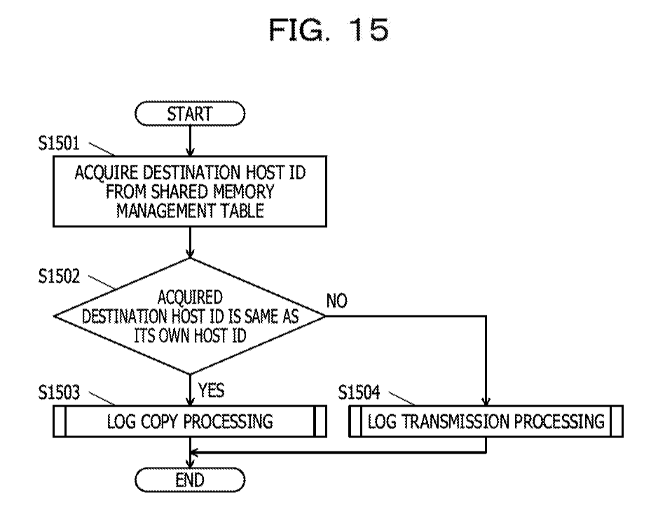

FIG. 15 is a flowchart illustrating an example of a determination processing procedure. Determination processing is processing for determining whether or not a guest OS including a master DB and a guest OS including a slave DB operate on the same physical machine. The determination processing is processing for realizing functions included in each of the determination units 1401 and is executed by a corresponding one of the host OSs.

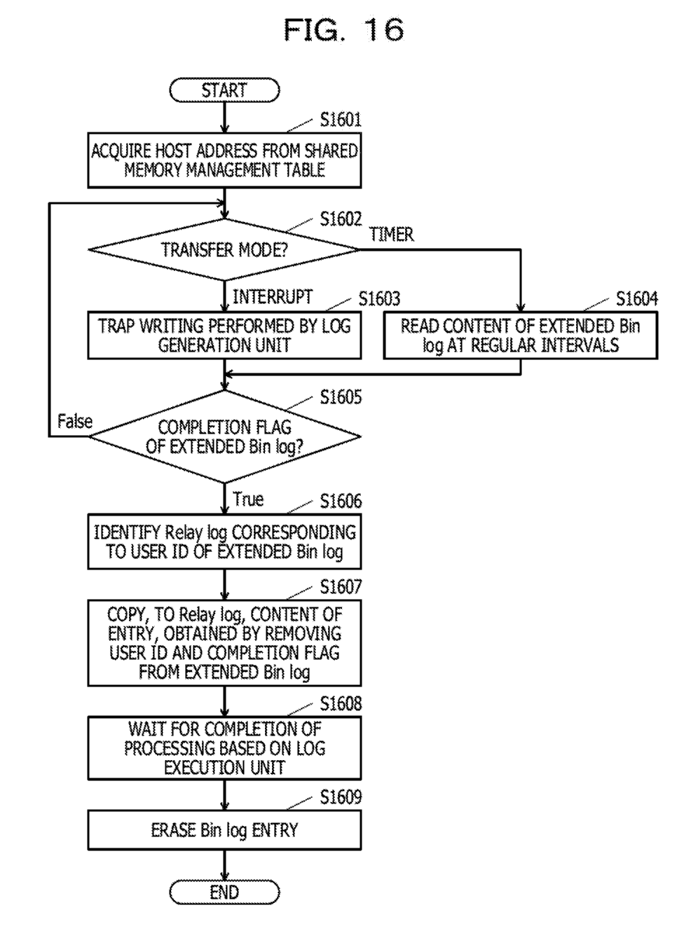

The corresponding one of the host OSs acquires a destination host ID from a corresponding one of the shared memory management tables 313 (step S1501). Next, the corresponding one of the host OSs determines whether or not the acquired destination host ID is the same as the host ID of the relevant host OS itself (step S1502). In a case where the acquired destination host ID is the same as the host ID of the corresponding one of the host OSs itself (step S1502: Yes), the relevant host OS performs log copy processing (step S1503). Details of the log copy processing will be described in FIG. 16. In addition, here, an instruction to designate as a transfer source device and an instruction to designate as a transfer destination device may be coupled as one piece of data or may be associated with each other while being separated as data.

On the other hand, in a case where the acquired destination host ID is different from the host ID of the corresponding one of the host OSs itself (step S1502: No), the relevant host OS performs log transmission processing (step S1504). The log transmission processing is identical to that described in FIG. 11.

After the processing operation in step S1503 or the processing operation in step S1504 finishes, the corresponding one of the host OSs terminates the determination processing. By performing the determination processing, the corresponding one of the host OSs is able to determine whether or not the guest OS including the master DB and the guest OS including the slave DB operate on the same physical machine.

FIG. 16 is a flowchart illustrating an example of a log copy processing procedure. Log copy processing is processing for copying a log. The log copy processing is processing for realizing functions included in each of the copying units 1402 and is processing performed by a corresponding one of the host OSs.

The corresponding one of the host OSs acquires a host address from a corresponding one of the shared memory management tables 313 (step S1601). Next, the corresponding one of the host OSs confirms the transfer mode (step S1602). In a case where the transfer mode is the interrupt (step S1602: Interrupt), the corresponding one of the host OSs traps writing performed by the log generation unit 305 (step S1603). On the other hand, in a case where the transfer mode is the timer (step S1602: Timer), the corresponding one of the host OSs reads a content of the extended bin log 121 at regular intervals (step S1604).

After the processing operation in step S1603 or step S1604 finishes, the corresponding one of the host OSs confirms the completion flag of the extended bin log 121 (step S1605). In a case where the completion flag of the extended bin log 121 is False (step S1605: False), the corresponding one of the host OSs makes a transition to the processing operation in step S1602. On the other hand, in a case where the completion flag of the extended bin log 121 is True (step S1605: True), the corresponding one of the host OSs identifies a corresponding one of the relay logs 131, which corresponds to a user ID of the extended bin log 121 (step S1606).

Next, the corresponding one of the host OSs copies, to the corresponding one of the relay logs 131, a content of an entry, obtained by removing the user ID and the completion from the extended bin log 121 (step S1607). In addition, the corresponding one of the host OSs waits for completion of processing based on a corresponding one of the log execution units 306 (step S1608). After the corresponding one of the log execution units 306 completes the processing, the corresponding one of the host OSs erases the entry of the extended bin log 121 (step S1609). After the processing operation in step S1609 finishes, the corresponding one of the host OSs terminates the log copy processing. By performing the log copy processing, the corresponding one of the host OSs is able to write, into a corresponding one of the slave DBs 132, data written into the master DB 122.

As described above, in the redundant system 1300, a corresponding one of the host OSs, which manages one of the guest OSs, designated as a transfer source device, may properly use copying between memories and transfer via the management LAN 111, depending on whether or not another one of the guest OSs managed by the corresponding one of the host OSs itself is designated as a transfer destination device. Accordingly, in a case of using the copying between memories, the redundant system 1300 is able to suppress a load on the management LAN 111 and to reduce an amount of time taken to perform replication by an amount of time taken to pass through the management LAN 111. In addition, the redundant system 1300 is able to deal with a case where a DB serving as a transfer source or a DB serving as a transfer destination migrates.

### Description of Third Embodiment

A redundant system according to a third embodiment is a system able to deal with a case where one of the masters DB 122 and one of the slave DBs 132 are mixed in one of the physical machines pm. The same symbols are assigned to parts similar to respective parts described in the first embodiment, and the illustrations and descriptions thereof will be omitted.

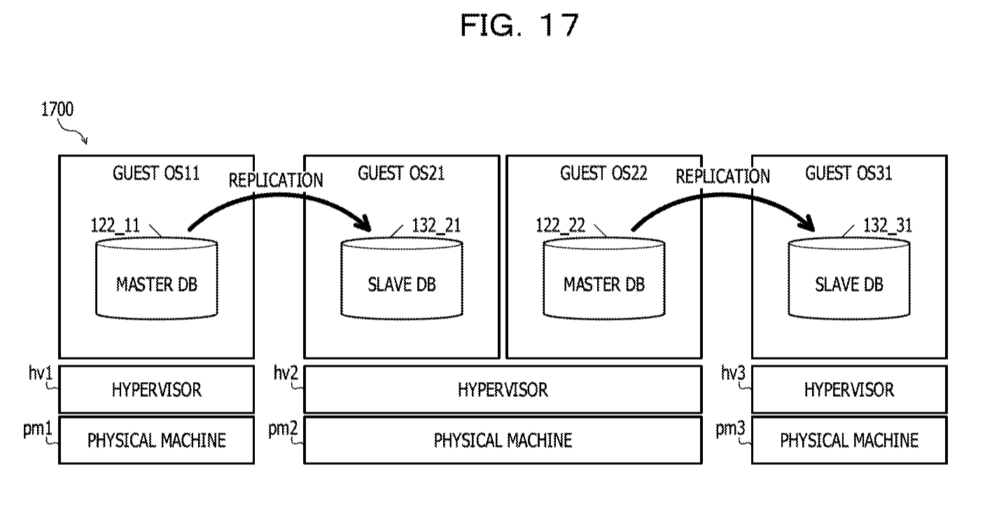

FIG. 17 is an explanatory diagram illustrating an example of an operation of a redundant system 1700 according to the third embodiment. In the redundant system 1700 illustrated in FIG. 17, the physical machine pm1 causes the guest OS 11 to operate. In addition, the physical machine pm2 causes the guest OS 21 and the guest OS 22 to operate. In addition, a physical machine pm3 causes a guest OS 31 to operate. Note that while not illustrated in FIG. 17, the physical machine pmm exists within the redundant system 1700 and the physical machines pm1, pm2, and pm3 each cause one of the host OSs to operate.

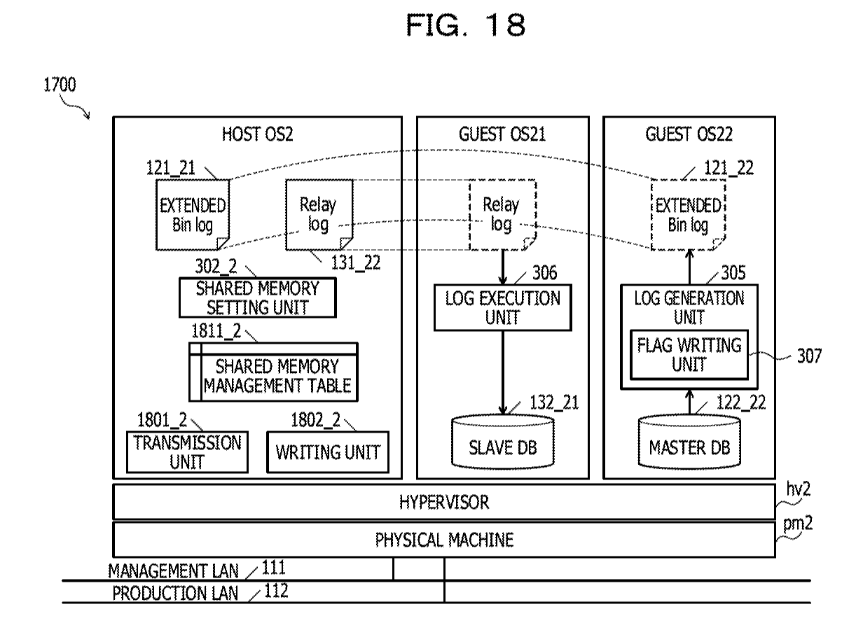

As illustrated in FIG. 17, replication is performed between the master DB 122_11 included in the guest OS 11 and the slave DB 132_21 included in the guest OS 21. In addition, replication is performed between a master DB 122_22 included in the guest OS 22 and a slave DB 132_21 included in the guest OS 31. In this way, a configuration in which the physical machine pm2 includes the slave DB 132_21 and the master DB 122_22 is adopted. Next, an example of a functional configuration of the redundant system 1700 will be described by using FIG. 18.

FIG. 18 is an explanatory diagram illustrating an example of the functional configuration of the redundant system 1700. In FIG. 18, since examples of functional configurations of the physical machines pmm, pm1, and pm3 are the same as those illustrated in FIG. 3, the illustrations thereof will be omitted.

The host OS 2 includes the shared memory setting unit 302_2, a transmission unit 1801_2, and a writing unit 1802_2.

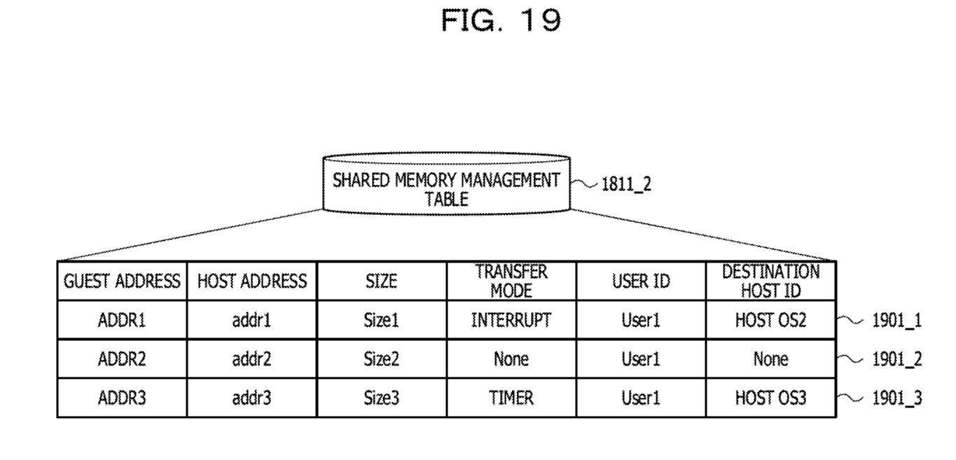

In addition, the corresponding one of the hosts OS is able to access the shared memory management table 1811_2. The shared memory management table 1811_2 is stored in a storage device such as the RAM 203 or the disk 205 in the physical machine pm2. An example of storage contents of the shared memory management tables 1811 will be described in FIG. 19.

From among entries of the shared memory management table 1811_2, in each of which the transfer mode is not None, the transmission unit 1801_2 identifies a shared memory for transfer, which is to serve as a target. In addition, the transmission unit 1801_2 transmits, to a destination device via the management LAN 111, data written into the identified shared memory for transfer.

From among entries of the shared memory management table 1811_2, in each of which the transfer mode is None, the writing unit 1802_2 identifies a shared memory for reception, which is to serve as a target. In addition, the writing unit 1802_2 writes data received via the management LAN 111, into the identified shared memory for reception.

FIG. 19 is an explanatory diagram illustrating an example of storage contents of the shared memory management tables 1811. In FIG. 19, the shared memory management table 1811_2 will be used and described. The shared memory management table 1811_2 illustrated in FIG. 19 includes entries 1901_1 to 1901_3.

In one of the shared memory management tables 1811, designation of a transfer source device and designation of a transfer destination device are mixed. Specifically, since having no transfer mode of None, the entries 1901_1 and 1901_3 are entries that each receive designation of a transfer source device. On the other hand, since having the transfer mode of None, the entry 1901_2 is an entry that receives designation of a transfer destination device. By referencing the transfer mode fields of entries of the corresponding one of the shared memory management tables 1811, each of the corresponding one of the transmission units 1801 and the corresponding one of the writing units 1802 is able to identify whether being designation of a transfer source device or designation of a transfer destination device. In addition, by referencing the destination host ID fields of entries of the corresponding one of the shared memory management tables 1811, each of the corresponding one of the transmission units 1801 and the corresponding one of the writing units 1802 may identify whether being designation of a transfer source device or designation of a transfer destination device.

As described above, according to the redundant system 1700, even in a case where one of the master DBs 122 and one of the slave DBs 132 are mixed in one physical machine, it is possible to perform replication.

Note that while, in each of the first to third embodiments, data written into a shared memory is an update query, any type of data may be adopted. The first to third embodiments may be applied to a system in which data of a production system is simply backed up to data of a standby system, for example. In addition, in this case, the atomicity of data written into a shared memory does not have to be secured, and data written into a shared memory of a production system only has to be written into a shared memory of a standby system, as desired.

Note that a redundancy method described in the present embodiment may be realized by executing a preliminarily prepared program in a computer such as a personal computer or a workstation. The present replication program is recorded on a computer-readable recording medium such as a hard disk, a flexible disk, a Compact Disc-Read Only Memory (CD-ROM), or a Digital Versatile Disk (DVD) and is read from the recording medium by a computer, thereby being executed. In addition, the present replication program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a replication program that causes a first information processing apparatus to execute a process, the process comprising:
storing update information to a first shared storage area of a first virtual machine, the update information indicating update of data stored in a storage area of a second virtual machine, both the first virtual machine and the second virtual machine running on the first information processing apparatus, the first shared storage area being accessible from both the first virtual machine and the second virtual machine, the second virtual machine being a virtual machine of active system of data replication;
when an additional update information is stored in the first shared storage area, transmitting the additional update information to a third virtual machine, the third virtual machine running on a second information processing apparatus; and
causing the third virtual machine to store the additional update information in a second shared storage area of the third virtual machine, the second shared storage area being accessible from both the third virtual machine and a fourth virtual machine running on the information processing apparatus, the fourth virtual machine being a virtual machine of standby system of the data replication, the additional update information stored in the second shared storage area being used to update data stored in a storage area of the fourth virtual machine.

2. The non-transitory computer-readable storage medium according to claim 1, wherein the process further comprises:
setting the first shared storage area in response to reception of an instruction including an identifier of the second virtual machine as a designation of a transfer source device of the data replication; and
setting the second shared storage area in response to reception of an instruction including an identifier of the fourth virtual machine as a designation of a destination device of the data replication and including information indicating a storage area that corresponds to the designation of a destination device.

3. The non-transitory computer-readable storage medium according to claim 1, wherein
the additional update information is transmitted via a network for management in which a restriction is imposed on accesses from virtual machines.

4. The non-transitory computer-readable storage medium according to claim 2, wherein
the identifier of the second virtual machine and the identifier of the fourth virtual machine are an identifier of a user of the second virtual machine and the fourth virtual machine; wherein
the transmitting including transmitting the additional update information and the identifier of the user.

5. The non-transitory computer-readable storage medium according to claim 2, wherein
setting the third shared storage area in response to reception of an instruction including an identifier of the fifth virtual machine as the designation of the destination device and including information indicating the storage area that corresponds to the designation of the destination device, the fifth virtual machine running on the first information processing apparatus, the third shared storage area being accessible from both the first virtual machine and the fifth virtual machine, the fifth virtual machine being the virtual machine of standby system of data replication; and
when the additional update information is stored in the first shared storage area, copying the additional update information from the first shared storage area to the third shared storage area, the additional update information stored in the third shared storage area being used to update data stored in a storage area of the fifth virtual machine.

6. The non-transitory computer-readable storage medium according to claim 1, wherein
the additional update information is an entire update query for the storage area of a second virtual machine.

7. The non-transitory computer-readable storage medium according to claim 1, wherein
an IP address of the second virtual machine and an IP address of the fourth virtual machine are set by a template including setting information of an IP address.

8. A redundant system comprising:
a first information processing apparatus including:
a first memory; and
a first processor coupled to the first memory; and
a second information processing apparatus including:
a second memory; and
a second processor coupled to the second memory; wherein
the first processor is configured to:
store update information to a first shared memory area, in the first memory, allocated to a first virtual machine, the update information indicating update of data stored in a storage area of a second virtual machine, both the first virtual machine and the second virtual machine running on the first information processing apparatus, the first shared memory area being accessible from both the first virtual machine and the second virtual machine, the second virtual machine being a virtual machine of active system of data replication;
when an additional update information is stored in the first shared memory area, transmit the additional update information to a third virtual machine, the third virtual machine running on the second information processing apparatus; and
cause the third virtual machine to store the additional update information in a second shared memory area allocated to the third virtual machine, the second shared memory area being accessible from both the third virtual machine and a fourth virtual machine running on the information processing apparatus, the fourth virtual machine being a virtual machine of standby system of the data replication, the additional update information stored in the second shared memory area being used to update data stored in a storage area of the fourth virtual machine.

9. A replication method executed by a first information processing apparatus, the replication method comprising:
storing update information to a first shared storage area of a first virtual machine, the update information indicating update of data stored in a storage area of a second virtual machine, both the first virtual machine and the second virtual machine running on the first information processing apparatus, the first shared storage area being accessible from both the first virtual machine and the second virtual machine, the second virtual machine being a virtual machine of active system of data replication;
when an additional update information is stored in the first shared storage area, transmitting the additional update information to a third virtual machine, the third virtual machine running on a second information processing apparatus; and
causing the third virtual machine to store the additional update information in a second shared storage area of the third virtual machine, the second shared storage area being accessible from both the third virtual machine and a fourth virtual machine running on the information processing apparatus, the fourth virtual machine being a virtual machine of standby system of the data replication, the additional update information stored in the second shared storage area being used to update data stored in a storage area of the fourth virtual machine.
